(19) United States
(12) Patent Application Publication
(10) Pub. No.: US 2026/0279217 A1
(43) Pub. Date: Sep. 17, 2026

(54) SYSTEM, APPARATUS AND KIT FOR THEMATIC GAME-BASED LEARNING

(71) Applicant: Smrithi Sriram, Cedar Park, TX (US)

(72) Inventor: Smrithi Sriram, Cedar Park, TX (US)

(21) Appl. No.: 19/080,803

(22) Filed: Mar. 15, 2025

(51) Int. Cl. G09B 7/02; G06T 11/00; G06T 13/00; G06V 20/50; G10L 15/183; G10L 15/22

(52) U.S. Cl. CPC G09B 7/02; G06T 11/00; G06T 13/00; G06V 20/50; G10L 15/183; G10L 15/22

(57) ABSTRACT

System, apparatus and kit for thematic game-based learning is disclosed. In one embodiment, a thematic game-based learning system includes a server, and user devices communicatively coupled to the server via a network. The server includes a theme-based learning module is configured to generate a virtual game board having a plurality of spaces. The plurality of spaces includes a start space, an end space, one or more spaces having icons of different types corresponding to a knowledge-based learning sub-theme. The server is configured to generate stacks of virtual cards corresponding to unique knowledge-based learning sub-themes. Each virtual card includes a theme-based learning challenge. The server is configured to dynamically select a virtual card from a stack of virtual cards corresponding to a type of icon on which the virtual game piece is positioned, and display a theme-based learning challenge on the selected virtual card on the respective user devices.

### TECHNICAL FIELD

The present disclosure generally relates to a field of theme-based learning, and more particularly to a system, apparatus and kit for thematic game-based learning.

### BACKGROUND

Learning is often found to be difficult and boring when it is limited to rote memorization, and passive listening without any hands-on activities or quizzes or real-world applications. This makes it harder to retain the knowledge and applying it to real world problems.

### SUMMARY

System, apparatus and kit for thematic game-based learning is disclosed. The scope of the present disclosure is defined solely by the appended claims and is not affected to any degree by the statements within this summary. The present embodiments may obviate one or more of the drawbacks or limitations in the related art.

In one aspect, a thematic game-based learning system includes at least one server, and one or more user devices communicatively coupled to the server via a network. Each user device is associated with a player. The server includes a theme-based learning module configured to generate a virtual game board having a plurality of spaces. The plurality of spaces includes a start space, an end space, one or more of spaces between the start space and the end space having icons of different types. Each type of icon corresponds to a knowledge-based learning sub-theme. The theme-based learning module is configured to generate one or more stacks of virtual cards. Each stack of virtual cards corresponds to the knowledge-based learning sub-theme. Each virtual card from the stack of virtual cards includes a theme-based learning challenge.

The theme-based learning module may be configured to determine a number indicated on a dice when a player rolls the dice, move a virtual game piece of the player in a forward direction by one or more spaces in the virtual game board displayed on the user devices from previous position based on the number indicated on the rolled dice, dynamically select a virtual card from the stack of virtual cards corresponding to a type of icon on which the virtual game piece is positioned, and display the theme-based learning challenge on the selected virtual card on the respective user devices.

The theme-based learning module may be configured to determine whether an answer from the player to the theme-based learning challenge on the displayed virtual card is correct. If it is determined that the answer from the player is not correct, the theme-based learning module may be configured to move the virtual game piece of the player backwards on the displayed game board by at least one space from the current position. Alternatively, if it is determined that the answer from the player is correct, the theme-based learning module may be configured to determine a number on the dice rolled by the player and move the virtual game piece of the player by one or more spaces on the displayed game board from the previous position based on the determined number on the dice.

Each user device may include an image capturing unit, configured to capture an image of the top surface of the dice when each player rolls the dice and/or a voice capturing unit configured to capture the answer corresponding to the theme-based learning challenge on the displayed virtual card.

The theme-based learning module may be configured to receive the captured answer corresponding to the theme-based learning challenge from said each device, and determine whether the answer from the player to the theme-based learning challenge on the displayed virtual card is correct using a trained machine learning model based on the correct answer.

The theme-based learning module may be configured to determine whether the virtual game piece is positioned on the space having the icon. If the virtual game piece is positioned on the space having the icon, the theme-based learning module may be configured to determine the type of the icon on which the virtual game piece is positioned, and dynamically select the virtual card from the corresponding stack of virtual cards corresponding to the type of icon.

The theme-based learning module may be configured to move the virtual game piece of the player backwards to the previous position of the virtual game piece on the virtual game board. The theme-based learning module may be configured to dynamically generate the virtual game board with the plurality of spaces divided into two or more zones. Each zone corresponds to a unique knowledge-based learning sub-theme.

In another aspect, a thematic game-based learning apparatus includes a physical game board having a plurality of spaces, two or more IoT-enabled game pieces assigned to players, a dice having six sides numbered 1 to 6, a processing unit communicatively coupled to the one or more IoT-enabled game pieces, and a display unit coupled to the processing unit. The plurality of spaces includes a start space, an end space, and one or more of spaces between the start space and the end space having one or more icons of different types. Each type of icon corresponds to a unique knowledge-based learning sub-theme. The physical game board with the plurality of spaces is divided into two or more zones. Each zone corresponds to the unique knowledge-based learning sub-theme. The processing unit includes a theme-based learning module configured to dynamically generate one or more stacks of virtual cards. Each stack of virtual cards corresponds to each type of icons. Each virtual card in the stack of virtual cards includes a unique theme-based learning challenge. The theme-based learning module is configured to determine location of the game piece associated with each player on the game board when the game piece is moved to a new position on the game board after rolling of the dice, select a virtual card from the stack of virtual cards corresponding to the type of icon on which the game piece is positioned. The display unit is configured to display the virtual card with the theme-based learning challenge.

The thematic game-based learning apparatus may include a voice capturing unit configured to capture the answer corresponding to the theme-based learning challenge on the displayed virtual card from the player associated with the IoT-enabled game piece.

The theme-based learning module may be configured to determine whether the captured answer from the player to the theme-based learning challenge on the displayed virtual card is correct, and render result of the answer to the theme-based learning challenge on the display unit. Based on the result, the IoT-enabled game piece of the player is moved backwards on the game board by at least one space if the answer of the player is not correct and the player is given another chance to roll the dice if the answer of the player is correct.

The theme-based learning module may be configured to receive the captured answer corresponding to the theme-based learning challenge from the voice capturing unit, and determine whether the received answer from the player to the theme-based learning challenge on the displayed virtual card is correct using a trained machine learning model based on a correct answer.

The theme-based learning module may be configured to determine whether the IoT-enabled game piece is positioned on the space having the icon on the game board. If the IoT-enabled game piece is positioned on the space having the icon, the theme-based learning module may be configured to determine the type of the icon on which the IoT-enabled game piece is positioned, and dynamically select the virtual card from the stack of virtual cards corresponding to the icon.

The theme-based learning module may be configured to determine the position of the IoT-enabled game piece based on location information received from the IoT-enabled game piece, map the position of the IoT-enabled game piece to a virtual replica of game board based on the position of the IoT-enabled game piece, and determine whether the position of the IOT-enabled game piece corresponds to the location of the icon on the virtual replica of game board.

In yet another aspect, a thematic game-based learning kit includes a physical game board having a plurality of spaces. The game board may consist of the plurality of spaces in the form of a track. The plurality of spaces may be divided into two or more zones, each zone corresponds to a unique knowledge-based learning sub-theme. The plurality of spaces includes a start space, an end space, and one or more of spaces between the start space and the end space having icons of one or more types. Each type of icon corresponds to the knowledge-based learning sub-theme. The thematic game-based learning kit includes at least one dice consisting of six sides indicating numbers 1 to 6, two or more game pieces assigned to two or more players, and one or more stacks of cards. Each stack of cards corresponds to the knowledge-based learning sub-theme. Each card from the stack of cards includes a unique theme-based learning challenge. The game piece of the player who rolled the dice is moved by one or more spaces on the game board from previous position on the game board in the direction of the end space based on the number indicated on the rolled dice. A card is drawn from the stack of cards corresponding to a type of icon if the game piece associated with the player is positioned on the icon after rolling the dice. The player is given a chance to answer the theme-based learning challenge on the card. The answer to the theme-based learning challenge is provided on back of the card.

The game piece is moved backwards on the game board by at least one space if the answer to the theme-based learning challenge on the drawn card is not correct, whereas the player is given additional chance to roll the dice if the answer to the theme-based learning challenge is correct.

Each game piece may be an IoT-enabled game piece configured to determine position with respect to the game board when the IoT-enabled game piece is moved from the previous position to the new position upon rolling the dice. The position is indicative of location of the IoT-enabled game piece on the game board. The game piece is configured to communicate position data indicating the position of the IoT-enabled game piece to a processing unit such that the processing unit dynamically selects a virtual card from a stack of virtual cards corresponding to the icon if the IoT-enabled game piece is positioned on the icon.

### BRIEF DESCRIPTION OF THE DRAWINGS

The drawings described herein are for illustrative purposes and are not intended to limit the scope of the present subject matter in any way:

FIG. 1 is a block diagram of a thematic game-based learning system, according to one embodiment;

FIG. 2 is a block diagram depicting various sub-modules of the theme-based learning module as shown in FIG. 1, according to one embodiment;

FIG. 3 is a flowchart depicting an exemplary method of thematic game-based learning, according to one embodiment;

FIG. 4 is a block diagram of a thematic game-based learning system, according to another embodiment;

FIG. 5 is a block diagram depicting various sub-modules of the theme-based learning module as shown in FIG. 4, according to another embodiment;

FIG. 6 is a flowchart depicting an exemplary method of thematic game-based learning, according to another embodiment;

FIG. 7 is a schematic representation of a thematic board game kit for providing thematic-game based learning to players, according to yet another embodiment;

FIG. 8 is a graphical view of a thematic gaming interface displaying stacks of virtual cards, according to an embodiment;

FIG. 9 is a graphical view of a thematic gaming interface displaying a virtual card selected from the stack of virtual cards corresponding to a knowledge-based learning sub-theme, according to an embodiment;

FIG. 10 is a graphical view of a thematic gaming interface displaying result of answer to a theme-based learning challenge by a player, according to an embodiment; and

FIG. 11 is a block diagram of an IoT-enabled game piece such as those shown in FIG. 4, according to an embodiment.

### DETAILED DESCRIPTION

System, apparatus and kit for thematic game-based learning is disclosed. Various embodiments are described with reference to the drawings, wherein like reference numerals are used to refer the drawings, wherein like reference numerals are used to refer to like elements throughout. In the following description, for the purpose of explanation, numerous specific details are set forth in order to provide thorough understanding of one or more embodiments. It may be evident that such embodiments may be practiced without these specific details.

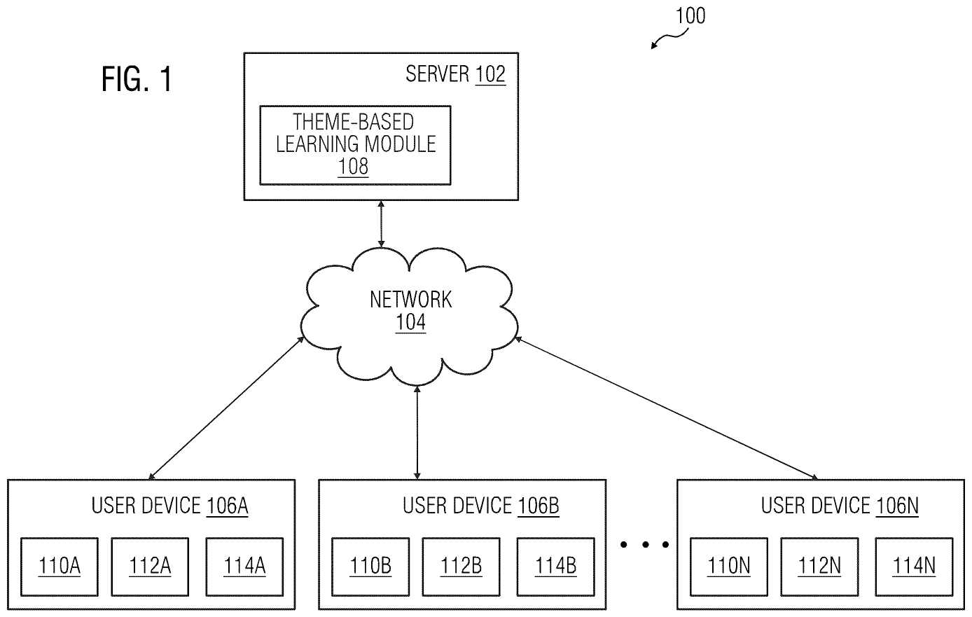

FIG. 1 is a block diagram of a thematic game-based learning system 100, according to one embodiment. The thematic game-based learning system 100 includes a server 102, a network 104, and user devices 106A-N. The server 102 is communicatively coupled to the user devices 106A-N via the network 104.

The server 102 is a computer or a group of computers configured to host online multiplayer game such as thematic learning-based game. The server 102 is configured to manage game environment including rendering virtual game board, movement of game pieces, enforcing game rules, and handle in-game communication. The server 102 may be a dedicated server, shared server, peer-to-peer server, cloud server, multi-player server, etc.

The user devices 106A-N may be desktop computers, laptop computers, tablets, smartphones, gaming stations and the like. Each of the user devices 106A-N may belong to a player playing the thematic learning-based game. Each of the user devices 106A-N is connected to the server 102 via the network 104. The user devices 106A-N are located in a same location or different geographical locations. The user devices 106A-N are capable of rendering information associated with the thematic learning-based game on a graphical display and communicating inputs (such as voice inputs, captured images, commands, messages) associated with the thematic learning-based game to the server 102.

The user devices 106A-N includes display units 110A-N, image capturing units 112A-N, and voice capturing units 114A-N respectively. The display units 110A-N may be a graphical display such liquid crystal display, light emitting diode display, organic light emitting diode display, active-matrix organic light emitting diode display, foldable display and the like. The display units 110A-N may be integrated in the user devices 106A-N like touch display for smart phones or external to the user devices 106A-N like display monitors.

The image capturing units 112A-N may be a front or rear camera of the user devices or a desktop camera connected to the user devices 106A-N via a USB cable or Wi-Fi. The image capturing units 112A-N are capable of capturing image of a player, and/or top face of dice. For example, the camera may be high-definition camera. The voice capturing units 114A-N may be a microphone of the user devices or a wearable microphone by the players for capturing voice input from the players.

In one embodiment, the server 102 includes a theme-based learning module 108 configured to provide knowledge based thematic learning to players via a game. For example, each player may have to answer a unique theme-based learning challenge (e.g., related to environment) while playing a game. This imparts a theme-based learning to players through a game. The theme-based learning module 108 is configured to generate a virtual game board having a plurality of spaces (also known as blocks). The virtual game board has a start space and an end space. The start space is a block from which each player starts playing the game by rolling a dice. The end space is a block where the game ends when one of the players reaches the end space. The player whose game piece first lands on the end space is considered as a winner in the game. The virtual game board consists of multiple spaces between the start space and the end space. The spaces may be divided into zones. Each zone may be associated with a sub-theme. Consider that the virtual game board relates to a knowledge-based learning theme (e.g., sustainable environment), zones may be associated with sustainable water bodies, clean air, healthy soil, and noise free environment. One or more spaces in each of the zones may have icons (also known as symbols). The icons indicate that respective player shall be given an opportunity to perform a task (e.g., solving a theme-based learning challenge) when a game piece associated with the player lands on the icon.

The theme-based learning module 108 is configured to generate a plurality of stacks of virtual cards. Each stack of virtual cards is associated with the knowledge-based learning sub-theme. Each card in the stack of virtual cards contains a theme-based learning challenge. For example, if the theme selected by the players is sustainable environment, then the stacks of virtual cards may be associated with sustaining water bodies, clean air, noise free environment, and the like. In an instance, a theme-based learning challenge on a virtual card associated with sub-theme ‘clean air’ may include a question such as ‘If you travel to school everyday, how can you contribute to reducing air pollution?’.

The theme-based learning module 108 is configured to determine a number indicated on a dice when each player rolls the dice. The dice may be a physical dice which each player of the virtual board game rolls on a horizontal flat surface (e.g., floor) within view range of the image capturing unit 112. The theme-based learning module 108 is configured to determine a number on the dice based on the image captured by the image capturing unit 112. In an embodiment, the image capturing unit 112 may continuously capture images and determine which of the image has stable dice with a number (e.g., 1 to 6) indicated on top face. The respective user device 106 may send the image of the stable dice with the number indicated on the top face to the server 102 via the network 104. Accordingly, the theme-based learning module 108 may process the image of the dice and determine the number indicated on the dice.

The theme-based learning module 108 is configured to move a virtual game piece of respective player in a forward direction (e.g., direction of end space) from the previous position by number of spaces equal to the determined number on the rolled dice on the virtual game board displayed on the user devices 106. The theme-based learning module 108 is configured to determine whether the virtual game piece is positioned on a space with an icon on the virtual game board or not. If the virtual game piece is positioned on a space without any icon, the theme-based learning module 108 is configured to allow other player to roll the dice. If the virtual game piece is positioned on a space with an icon, the theme-based learning module 108 is configured to determine the type of icon on which the virtual game piece is positioned. For example, the icon may correspond to one of the knowledge-based learning sub-themes viz. sustainable water bodies, noise free environment, clean air, and healthy soil. If the type of icon corresponds to sustainable water bodies, the theme-based learning module 108 is configured to determine a stack of virtual cards corresponding to the type of icon. For example, each knowledge-based learning sub-theme may be assigned a unique code. The icon corresponding to the knowledge-based learning sub-theme is assigned corresponding unique code. Similarly, the stack of virtual cards corresponding to the icon is assigned the same unique code. The theme-based learning module 108 is configured to determine the unique code assigned to the icon based on the type of icon on which the virtual game piece is positioned. The theme-based learning module 108 is configured to select the stack of virtual cards corresponding to the type of icon based on the determined unique code.

The thematic based-learning module 108 is configured to dynamically select a virtual card from the selected stack of virtual card and display the selected virtual card on the display unit 110 of the user devices 106. The virtual card may display a unique theme-based learning challenge for the player whose virtual game piece is positioned on the icon on the virtual game board. The unique theme-based learning challenge may include a scenario-based question related to the knowledge-learning subtheme (e.g., ‘clean air’). For example, the scenario-based question may include ‘If you travel to school everyday, how can you contribute to reducing air pollution?’. The scenario-based questions may be dynamically generated based on the knowledge-based learning sub-theme associated with the unique code. The scenario-based learning questions may be dynamically generated based on location specific environmental issues based on a location of the player. The location specific environmental issues may be environment issues related to country, state or county. The stack of virtual cards with location specific environmental challenges based on the location of the player is generated using a trained artificial intelligence model (e.g., a trained large language model). In one embodiment, a large language model is trained to generate one or more location specific environment issues based on knowledge-based learning sub-theme and location of the player using accessible databases (e.g., vector databases). For example, the large language models may be trained to generate one or more theme-based learning challenge using Retrieval-Augmented Generation (RAG). Retrieval-Augmented Generation (RAG) is a technique which allows to generate questions or challenge based on the knowledge-based learning sub-theme and/or location. Alternatively, the large language model may be trained to generate questions or challenges using prompt engineering technique.

The theme-based learning module 108 is configured to determine if response to the displayed scenario-based question captured by the voice capturing unit 114 is correct. In some embodiments, the theme-based learning module 108 is configured to determine if the response to the displayed scenario-based question is correct using a trained machine learning model. In these embodiments, the trained machine learning model is configured to pre-process the voice-based response from the player using natural language understanding (NLU) and determine whether the answer from the player matches a pre-determined correct answer. For example, the machine learning model may be trained on large number datasets associated with a knowledge-based learning theme. The trained machine learning model may be supervised learning model such as logistic regression model to determine if the answer to the theme-based learning challenge is correct or not.

The theme-based learning module 108 is configured to allow the player, who answered the scenario-based question accurately, to roll the dice through a visual indication on the display unit 110. The theme-based learning module 108 is configured to move the virtual game piece of the player, who answered the scenario-based question, backwards (e.g., towards the direction of start space) by one space from current position on the virtual game board if the answer to the scenario-based question is incorrect. Alternatively, the theme-based learning module 108 is configured to position the virtual game piece of the player to previous position on the virtual game board if the answer to the scenario-based question is incorrect.

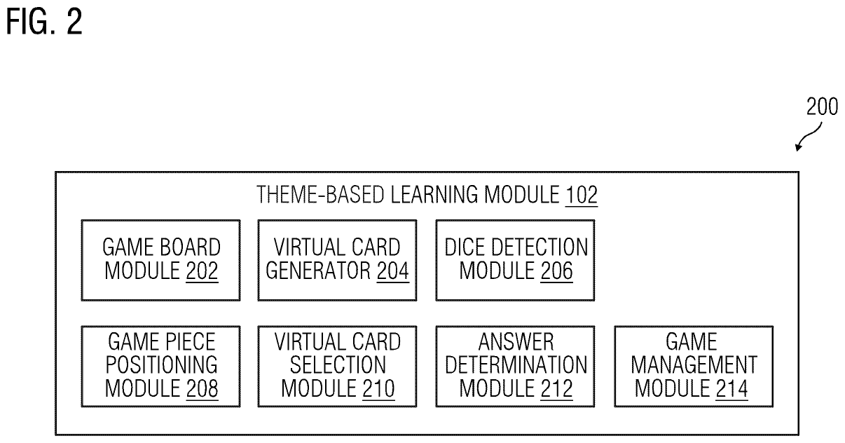

FIG. 2 is a block diagram depicting various sub-modules of the theme-based learning module 108 as shown in FIG. 1, according to an embodiment. The theme-based learning module 108 includes a game board module 202, a virtual card generator 204, a dice detection module 206, a game piece positioning module 208, a virtual card selection module 210, an answer determination module 212, and a game management module 214.

The game board module 202 is configured to generate a virtual game board having a plurality of spaces. The virtual game board may be divided into one or more zones. The zones may be associated with different knowledge-based learning sub-themes. The one or more spaces in each zone may have icons corresponding the knowledge-based learning sub-theme. In some embodiments, the game board module 202 may generate a virtual game board based on a pre-set configuration (e.g., topics for knowledge-based learning sub-themes). In other embodiments, the game board module 202 may dynamically generate a virtual game board having a plurality of zones corresponding to variety of knowledge-based learning sub-themes.

The virtual card generator 204 is configured to generate one or more stacks of virtual cards. The number of stacks of virtual cards may depend on number of knowledge-based learning sub-themes. Each virtual card in the stack of virtual cards corresponding to the knowledge-based learning sub-theme may contain a unique theme-based learning challenge. In one embodiment, the theme-based learning challenge may be a scenario-based question. In another embodiment, the theme-based learning challenge may be a location specific theme-based learning challenge. The location specific theme-based learning challenge is generated dynamically by a trained artificial intelligence model such as trained large language model based on location of player. Alternatively, the location specific theme-based learning challenge is generated dynamically by a trained large language model based on location selected by players. One skilled in the art can understand that the trained large language model is also configured to dynamically generate a theme-based learning challenge without considering location information.

The dice detection module 206 is configured to determine number on top of the dice rolled by a player upon his/her turn based on an image captured by a user device 106 associated with the player. The game piece positioning module 208 is configured to move a virtual game piece associated with respective player on the virtual game board from a current position based on the determined number on the rolled dice.

The virtual card selection module 210 is configured to determine whether the virtual game piece is positioned on a space with an icon. In some embodiments, the virtual card selection module 210 determines screen coordinates (X,Y) of the virtual game piece associated with the player on a display unit 110. The virtual card selection module 210 determines whether the screen coordinates (X,Y) of the virtual game piece matches with screen coordinates (X′, Y′) of any spaces with icons on the virtual game board. The virtual card selection module 210 determines type of icon on which the virtual game piece is positioned if the screen coordinates of the virtual game piece and the space with icon are same.

The virtual card selection module 210 determines a stack of virtual cards from the stacks of virtual cards and selects a virtual card with a unique theme-based learning challenge from the stack of the virtual card. In some embodiments, the type of icon on the virtual game board and the stack of virtual cards is assigned same unique ID. In these embodiments, the virtual card selection module 210 selects the stack of virtual cards based on the unique ID of the type of icon. The virtual card selection module 210 is configured to display the selected virtual card on a display unit 110 of a user device 106 of the player (whose virtual game piece is positioned on an icon).

The answer determination module 212 is configured to determine whether the answer to the theme-based learning challenge on the displayed virtual card is correct using a trained machine learning model (e.g., supervised learning model) based on captured voice input and pre-determined answers retrieved from databases in real-time. The answer determination module 212 may display results on the display units 110 associated with the players.

The game management module 214 is configured to move the virtual game piece of the player backwards by one space on the virtual game board or to a previous position on the virtual game board if the answer to the theme-based learning challenge is incorrect. The game management module 214 is configured to allow the player to roll the dice for a second time if the answer to the theme-based learning challenge is correct. Alternatively, the game management module 214 is configured to move the virtual game piece of the player in a forward direction by one or more spaces (e.g., pre-configured by player) if the answer to the theme-based learning challenge is correct. The game management module 214 may record score of the players and display the score on the display units 110.

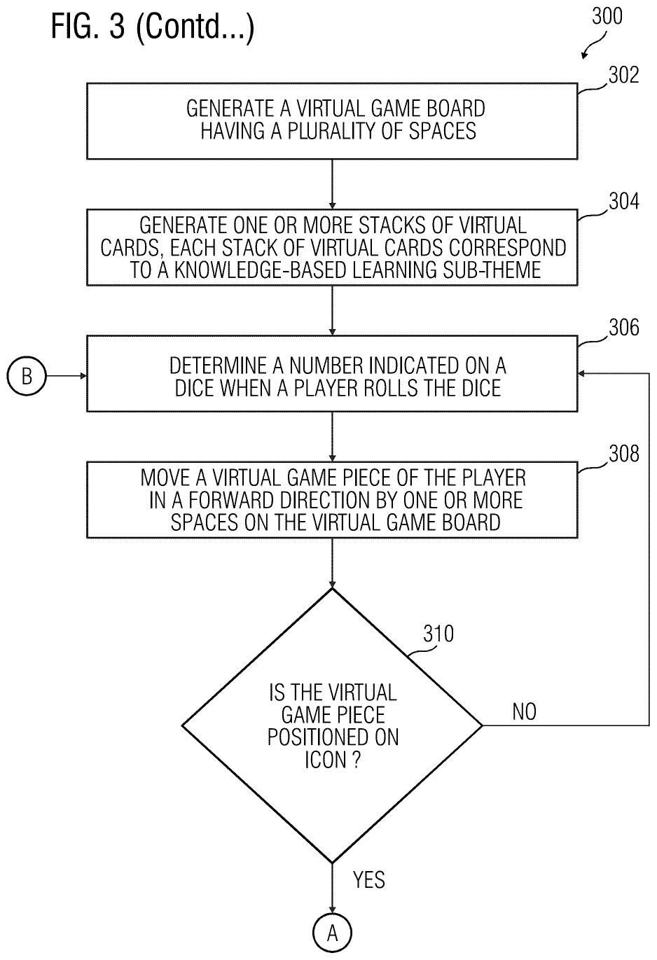

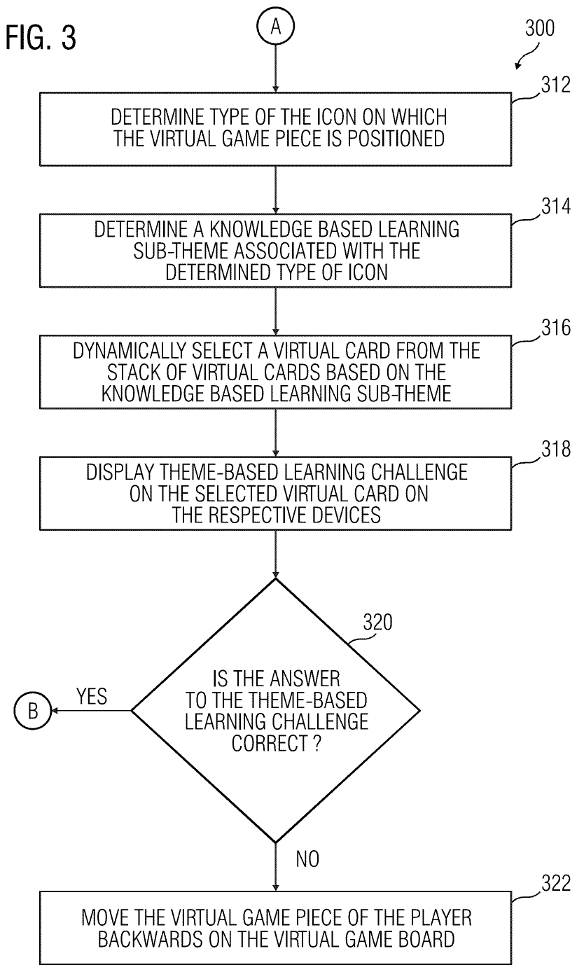

FIG. 3 is a flowchart 300 depicting an exemplary method of thematic game-based learning, according to one embodiment. At step 302, a virtual game board having a plurality of spaces is generated. The virtual game board consists of a start space, an end space and other spaces connecting the start space and the end space. The other spaces may be divided into zones. Each zone may correspond to unique knowledge-based learning sub-theme. One or more spaces in each zone may consist of an icon of specific type (e.g., which corresponds to the unique knowledge-based learning sub-theme).

At step 304, one or more stacks of virtual cards are generated by a server 102. Each stack of virtual cards may correspond to a unique knowledge-based sub-theme. Each stack of virtual cards may correspond to one of the zones on the virtual game board. Each card on the stack of virtual card contains a theme-based learning challenge associated with the unique knowledge-based sub-theme. The theme-based learning challenge may be a scenario-based question. In an embodiment, the scenario-based question may be associated with certain geography. For example, players may play games from different locations (e.g., USA and Canada). In such a case, scenario-based learning challenge may be based on their respective locations.

Each player may have a dice which each player rolls upon its turn to play the virtual board game. At step 306, a number indicated on a dice is determined using an image capturing device 110A when a player rolls the dice in front of the image capturing device 110A. At step 308, a virtual game piece of the player is moved in a forward direction by one or more spaces on the virtual game board based on the number indicated on the dice. For example, if the number on top of the dice is ‘5’, the virtual game piece of the player is moved by five spaces on the virtual game board from the current position.

At step 310, it is determined whether the virtual game piece is positioned on the space with an icon on the virtual game board. For example, screen coordinates of the virtual game piece associated with the player are determined based on the current position of the virtual game piece. The screen coordinates of the virtual game piece are checked against screen coordinates of icons displayed on the virtual game board. If there is a match in the screen coordinates, it is determined that the virtual game piece is positioned on the space with icon on the virtual game board. If the position of the virtual game piece is on the space with icon, at step 312, type of the icon on which the virtual game piece is positioned on the virtual game board is determined. In some embodiments, the type of icon is determined based on correlation between the screen coordinates of the zones and the screen coordinates of the icon on the virtual game board. If there is a match between the screen coordinates of one of the zones and the screen coordinates of the icon, the type of icon is determined based on the determined zone.

At step 314, a knowledge-based learning sub-theme associated with the type of icon is determined. For example, knowledge-based learning sub-theme may be sustaining water bodies, clean air, noise free environment, and the like. At step 316, a virtual card is dynamically selected from the stack of virtual cards based on the knowledge-based learning scheme.

At step 318, a unique theme-based learning challenge is displayed on the selected virtual card on respective user devices. At step 320, it is determined whether answer from the player to the theme-based learning challenge is correct based on voice of the player captured by a voice capturing unit. In some embodiments, the captured voice is input to a trained machine learning model. The trained machine learning model determines whether the answer to the theme-based learning challenge is correct. If the answer to the theme-based learning challenge is incorrect, at step 322, the virtual game piece of the player is moved backwards on the virtual game board. In one embodiment, the virtual game piece of the player is moved backwards (towards the start space) by one space. In another embodiment, the virtual game piece of the player is moved to the previous position from the current position on the virtual game board. If the answer to the theme-based learning challenge is correct, then the player may be given an additional chance to roll the dice. In such a case, the process 300 goes back to step 306 and steps 306 to 322 are repeated. The above steps are performed iteratively till one of virtual game pieces reaches the end space on the virtual game board. Advantageously, the players learn around knowledge-based learning sub-theme by answering unique theme-based learning challenges when a virtual game piece is positioned on icons on a virtual game board.

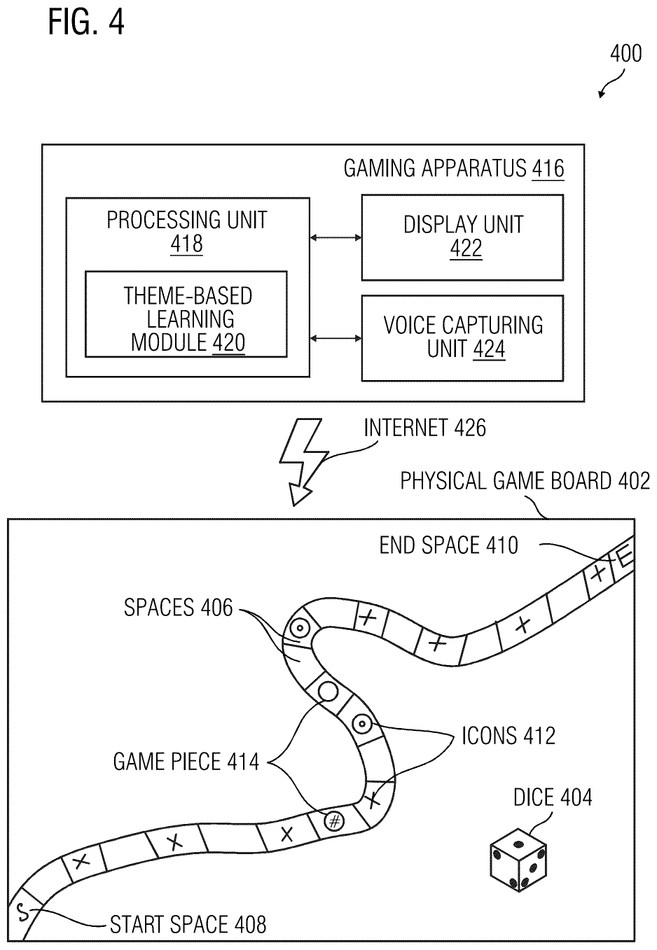

FIG. 4 is a block diagram of a thematic game-based learning system 400, according to another embodiment. The thematic game-based learning system 400 includes a physical game board 402 with a dice 404 and IoT-enabled game pieces 414, and a gaming apparatus 416.

The physical game board 402 consists of a plurality of spaces (also known as blocks). The physical game board 402 has a start space 408 and an end space 410. The start space 408 is a block from which each player starts playing the thematic game by rolling the dice 404. The end space 410 is a block where the game ends when one of the players reaches the end space 410. The physical game board 402 consists of multiple spaces 406 between the start space 408 and the end space 410. The spaces 406 may be divided into zones. Each zone may be associated with a sub-theme. One or more spaces in each of the zones may have icons 412 (also known as symbols such as ‘x’ and ‘+’). The icons 412 indicate that respective player shall be given an opportunity to perform a task (e.g., solving a theme-based learning challenge) when a game piece (e.g., the game pieces 414) associated with the player lands on the icon. The dice 404 is an object which has six sides. Each side of the dice 404 has a number indicated therein. Each player rolls the dice 404 on their turn so that the game piece 414 can be advanced from the start space 408 and the end space 410 based on the number on the top face of the dice 404. The game piece 414 is an IoT-enabled game piece capable of communicating location information (e.g., X and Y coordinates) to the gaming apparatus 416 via the Internet 426 or other near field communication means.

The gaming apparatus 416 includes a processing unit 418, a display unit 422, and a voice capturing unit 424. The processing unit 418 may be a computation circuit, such as but not limited to a microprocessor, microcontroller, complex instruction set computing microprocessor, reduced instruction set computing microprocessor, very long instruction word microprocessor, graphics processor, digital signal processor and the like. The processing unit 418 may also include embedded controllers, such as generic or programmable logic devices or arrays, application specific integrated circuits, single-chip computers, and the like.

The display unit 422 may be a graphical display such liquid crystal display, light emitting diode display, organic light emitting diode display, active-matrix organic light emitting diode display, foldable display and the like. The display unit 422 may be integrated within the gaming apparatus 416 like touch display for smart phones or external to the gaming apparatus 416 like display monitors or extended reality (XR) devices. The voice capturing unit 424 may be integrated microphone or a wearable microphone by the players for capturing voice input from the players.

The processing unit 418 includes a theme-based learning module 420 stored in the form of executable machine-readable instructions. The theme-based learning module 420 causes the processing unit 418 to provide knowledge based thematic learning experience to players using the physical board game 402. At the start of the game, the theme-based learning module 420 causes the processing unit 418 to generate a plurality of stacks of virtual cards. Each stack of virtual cards is associated with a unique knowledge-based learning sub-theme. Each card in the stack of virtual cards contains a unique theme-based learning challenge. For example, if the theme is sustainable environment, then the stacks of virtual cards may be associated with sustaining water bodies, clean air, noise free environment, and the like.

The theme-based learning module 420 causes the processing unit 418 to determine whether the game piece 414 is positioned on a space with an icon on the physical game board 402. Consider that a player rolls the dice 404 and moves his/her game piece 414 by a number of spaces on the physical game board 402 based on the number indicated on the dice 404. The theme-based learning module 420 causes the processing unit 418 to determine the position of the game piece 414 based on the location information received from the game piece 414. The theme-based learning module 420 causes the processing unit 418 to map the position of the game piece 414 to a virtual replica of the physical game board 402 based on the location information of the game piece 414. The theme-based learning module 420 causes the processing unit 418 to determine whether the position of the game piece 414 corresponds to the location of the icon on the virtual replica of the physical game board 402. If it is determined that the game piece 414 is positioned on a space without any icon on the physical game board 402, other player would roll the dice 404.

If the game piece 414 is positioned on a space with an icon on the physical game board 402, the theme-based learning module 420 causes the processing unit 418 to determine type of icon (e.g., ‘x’ or ‘+’ on which the game piece 414 is positioned. For example, the icon 412 may correspond to one of the knowledge-based learning sub-themes viz. sustainable water bodies (represented by ‘x’) or noise free environment (represented by ‘+’). If the type of icon 412 corresponds to sustainable water bodies, the theme-based learning module 420 causes the processing unit 418 to determine a stack of virtual cards corresponding to the type of icon 412. For example, each knowledge-based learning sub-theme may be assigned a unique code. The icon corresponding to the knowledge-based learning sub-theme is assigned the same unique code. Similarly, the stack of virtual cards corresponding to the icon is assigned the same unique code.

The theme-based learning module 420 determines the unique code assigned to the icon based on the type of icon on which the game piece 414 is positioned. The theme-based learning module 420 selects the stack of virtual cards corresponding to the type of icon based on the determined unique code. The theme-based learning module 420 causes the processing unit 418 to dynamically select a virtual card from the selected stack of virtual card and display the selected virtual card on the display unit 422. The virtual card may display a unique theme-based learning challenge for the player whose game piece 414 is positioned on the icon 412 on the physical game board 402.

The theme-based learning module 420 causes the processing unit 418 to determine if response to the displayed theme-based learning challenge captured by the voice capturing unit 424 is correct. In some embodiments, the theme-based learning module 420 causes the processing unit 418 to determine if the response to the displayed scenario-based question is correct using a trained machine learning model. In these embodiments, the trained machine learning model is configured to determine whether the answer from the player matches a correct answer. The theme-based learning module 420 causes the processing unit 418 to render result of the answer to the theme-based learning challenge on the display 422.

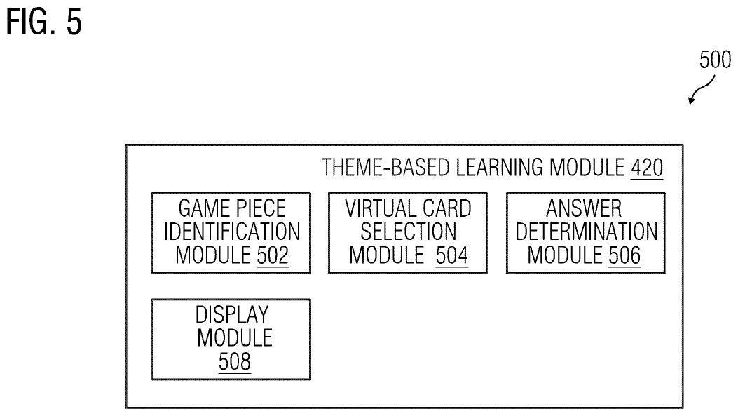

FIG. 5 is a block diagram depicting various sub-modules of the theme-based learning module 420 as shown in FIG. 4, according to an embodiment. The theme-based learning module 420 includes a game piece identification module 502, a virtual card selection module 504, an answer determination module 506, and a display module 508.

The game piece identification module 502 is configured to determine position of a game piece 414 on a physical game board 402 based on location data received from the game piece 414. The game piece identification module 502 is configured to map the determined position of the game piece 414 to a location on a virtual replica of the physical game board 402. The game piece identification module 502 is configured to determine whether the game piece 414 is positioned on a space with an icon on the physical game board 402 based on the mapping of the game piece 414 to the virtual replica of the physical game board 402.

The virtual card selection module 504 is configured to determines type of icon on which the game piece 414 is positioned if the game piece 414 is positioned on the space with icon on the physical game board 402. The virtual card selection module 504 is configured to identify a stack of virtual cards from the stacks of virtual cards based on the type of icon. The virtual card selection module 504 is configured to select a virtual card with a unique theme-based learning challenge from the stack of the virtual card. In some embodiments, the type of icon on the physical game board 402 and the stack of virtual cards is assigned same unique ID. In these embodiments, the virtual card selection module 504 selects the stack of virtual cards based on the unique ID of the type of icon. The virtual card selection module 504 is configured to display the selected virtual card with a unique theme-based learning challenge on a display unit 422.

The answer determination module 506 is configured to determine whether the answer to the theme-based learning challenge on the displayed virtual card is correct using a trained machine learning model based on captured voice input and answer retrieved from databases. The display module 508 is configured to display result of the answer along with a correct answer on the display unit 422.

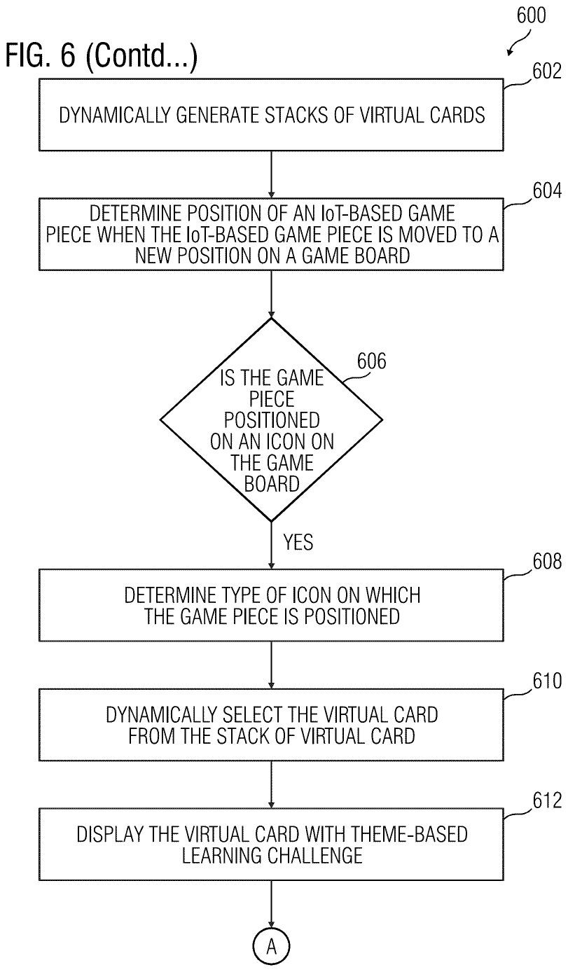

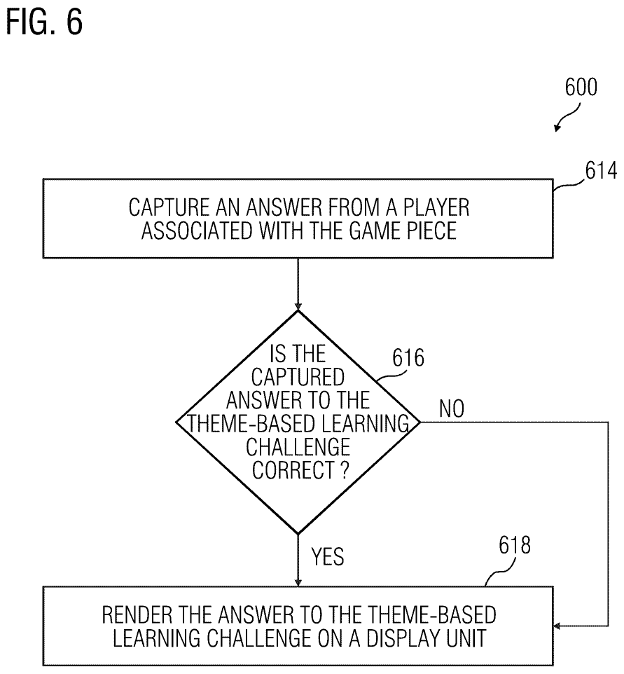

FIG. 6 is a flowchart 600 depicting an exemplary method of thematic game-based learning, according to another embodiment. At step 602, one or more stacks of virtual cards are dynamically generated by a gaming apparatus 416. Each stack of virtual cards may correspond to a unique knowledge-based sub-theme. Each stack of virtual cards may correspond to one of the zones on the virtual game board. Each card on the stack of virtual card contains a theme-based learning challenge associated with the unique knowledge-based sub-theme. The theme-based learning challenge may be a scenario-based question associated with the knowledge-based learning sub-theme.

Each player may roll a dice 404 upon their turn to play game using the physical game board 402. The player moves its game piece 414 in a forward direction by one or more spaces 406 on the physical game board 402 based on the number on the rolled dice 404. For example, if the number on top of the dice is ‘5’, the game piece 414 of the player is moved by five spaces on the physical game board 402 from the current position.

At step 604, position of the game piece 414 on the physical game board 402 is determined based on location information received from the game piece 414. For example, the position of the game piece 414 on the physical game board 402 is determined when the game piece 414 is moved to a new position on the physical game board 402.

At step 606, it is determined whether the game piece 414 is positioned on a space with an icon on the physical game board 402. The position of the game piece 414 is mapped to a virtual replica of the physical game board 402. It is determined whether the game piece 414 is positioned on the space with the icon on the physical game board 402 based on the mapping of the position of the game piece 414 to the virtual replica of the physical game board 402.

If the position of the game piece 414 is on the space with icon, at step 608, type of the icon on which the game piece 414 is positioned on the physical game board 402 is determined. Also, a knowledge-based learning sub-theme associated with the type of icon is determined. For example, knowledge-based learning sub-theme may be sustaining water bodies, clean air, noise free environment, and the like. At step 610, a virtual card is dynamically selected from the stack of virtual cards corresponding to the knowledge-based learning scheme.

At step 612, the selected virtual card with a unique theme-based learning challenge is displayed on the display unit 422. At step 614, an answer to the theme-based learning challenge is captured from the player associated with the game piece 414 using a voice capturing unit 424.

At step 616, it is determined whether answer from the player to the theme-based learning challenge is correct based on voice of the player captured by the voice capturing unit 424. In some embodiments, the captured voice is input to a trained machine learning model. The trained machine learning model pre-processes the voice-based answer using natural language understanding algorithm and determines whether the answer to the theme-based learning challenge is correct. If the answer to the theme-based learning challenge is correct, at step 618, the answer to the theme-based learning challenge is rendered on the display unit 422. The above steps are performed iteratively till one of the game pieces 414 reaches the end space on the physical game board 402. Advantageously, the players learn around knowledge-based learning sub-theme by answering unique theme-based learning challenges every time a game piece 414 is positioned on icon 412 on a physical game board 402.

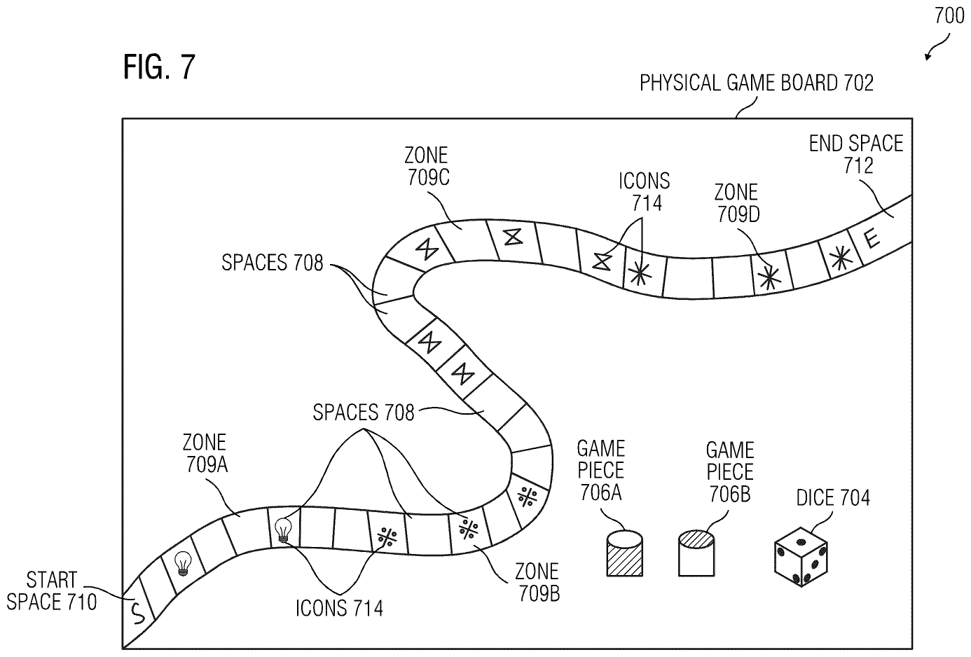

FIG. 7 is a schematic representation of a thematic board game kit 700 for providing thematic-game based learning to players, according to yet another embodiment. The thematic board game kit 700 includes a physical game board 702, a dice 704, and game pieces 706A-B.

The physical game board 702 has a plurality of spaces 708 in the form of a track. The plurality of spaces 708 are divided into four zones 709A-D. Each of the zones 709A-D corresponds to a unique knowledge-based learning sub-theme. The plurality of spaces 708 consists of a start space 710 and an end space 712. Few of the spaces between the start space 710 and the end space 712 includes icons 714 of one or more types. Each type of icon 714 corresponds to a unique knowledge-based learning sub-theme. The thematic board game kit 700 includes stacks of cards (not shown). Each stack of cards corresponds to the knowledge-based learning sub-theme. Each card from the stack of cards includes a unique theme-based learning challenge. The answer to the theme-based learning challenge is provided on back of respective card. Alternatively, stacks of virtual cards can be used. The stacks of virtual cards are generated dynamically by a computer at the start of thematic game.

The dice 704 is an object which has six sides marked with numbers 1 to 6. The dice is rolled by players on a floor or flat surface to determine number of spaces their respective game pieces 706A-B shall be moved on the physical game board 702. The game pieces 706A-B, assigned to players, are used to make movement from the start space 710 to the end space 712. In some embodiments, the game pieces are IoT-enabled and are capable of continuously communicating position information to the computer. The position information indicates position of the game pieces 706A-B on the physical game board 702.

For example, when the dice 704 is rolled by a player (assigned game piece 706A), a number indicated on top face of the dice 704 is considered. Accordingly, the game piece 706A is moved by the number of spaces 708 indicated on the dice 704 in a forward direction from a previous position on the physical game board 702. If the game piece 706A is positioned on a space 708 with an icon 714 (e.g., bulb), the player picks up a card from a stack of card corresponding to specific type of icon (e.g., knowledge-based learning sub-theme). Alternatively, the computer (e.g., gaming console) connected to the game piece 706A selects a virtual card from corresponding stack of virtual cards based on type of icon and displays theme-based learning challenge on a graphical user interface.

The player has to answer a theme-based learning challenge on the card. The answer is verified against an answer on back of the card. If the answer is correct, the player is allowed to roll the dice 704 again and the above steps are repeated. If the answer is incorrect, the game piece of the player is moved to a previous position on the physical game board 702. Another player is given a chance to roll the dice 704. The game continues till the game piece of one of the players reaches the end space 712. The player whose game piece reaches the end space first is declared as a winner. Different physical game board corresponding to different themes can be used for purpose of thematic game-based learning.

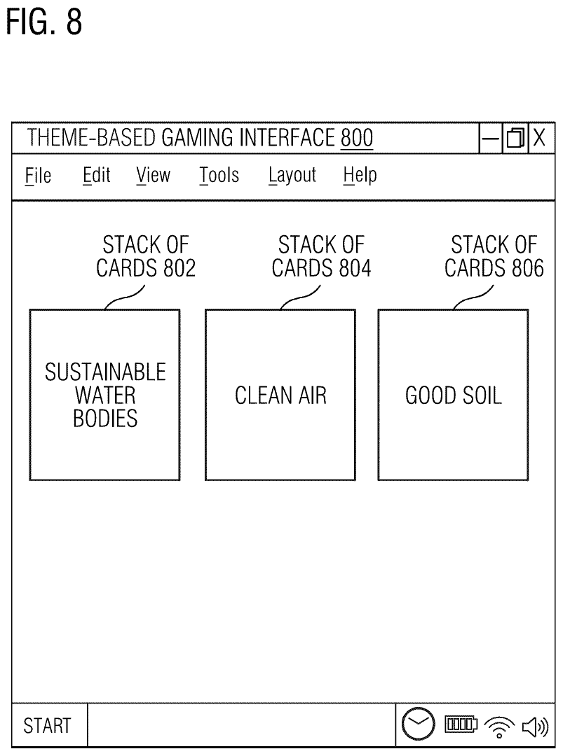

FIG. 8 is a graphical view of a thematic gaming interface 800 displaying stacks of virtual cards 802, 804, and 806, according to an embodiment. The thematic gaming interface 800 is an interface displayed on a display unit (e.g., display unit 422 of FIG. 4). The thematic gaming interface 800 displays a plurality of stacks of virtual cards 802, 804, and 806 generated by a theme-based learning module (e.g., theme-based learning module 108 or theme-based learning module 420). The stacks of virtual cards 802, 804, and 806 are associated with knowledge-based learning theme (e.g., environment). Each of stack of virtual cards may be associated with knowledge-based learning sub-theme (e.g., sustainable water bodies). As shown in FIG. 8, the stack of virtual cards 802 consists of virtual cards containing theme-based learning challenges related to sub-theme ‘sustainable water bodies’. Similarly, the stack of virtual cards 804 consists of virtual cards containing theme-based learning challenges related to sub-theme ‘clean air’. The stack of virtual cards 806 consists of virtual cards containing theme-based learning challenge related to sub-theme ‘good soil’. The number of stacks of virtual cards may depend on number of knowledge-based learning sub-themes. The knowledge-based learning sub-themes can be configured by players at the start of thematic game.

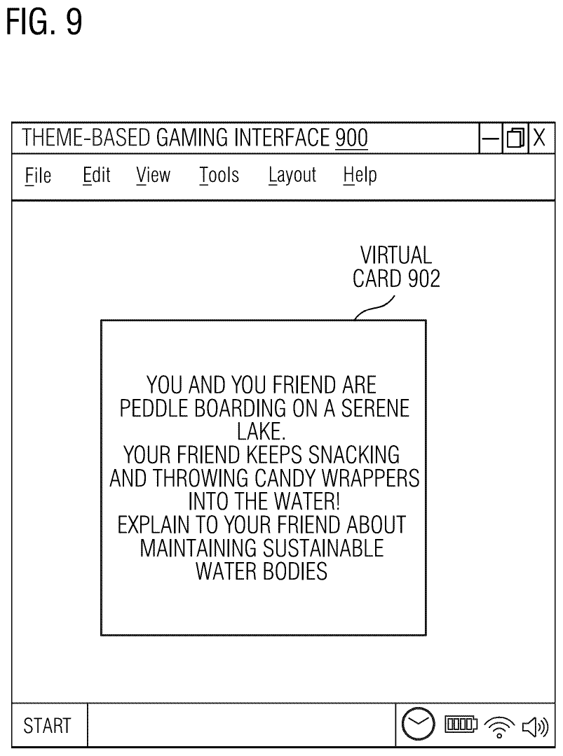

FIG. 9 is a graphical view of a thematic gaming interface 900 displaying a virtual card selected from a stack of virtual cards corresponding to a knowledge-based learning sub-theme, according to an embodiment. The thematic gaming interface 900 is an interface displayed on a display unit (e.g., a display unit 422). The thematic gaming interface 900 displays a virtual card 902 selected from a stack of virtual cards (e.g., the stack of virtual cards 802). The virtual card 902 is selected from the stack of virtual cards based on type of icon on which a game piece of a player is positioned. The virtual card 902 may display a theme-based learning challenge. The theme-based learning challenge may be related to a knowledge-based learning sub-theme associated with the type of icon. The theme-based learning challenge may be a scenario-based question associated with the knowledge-based learning sub-theme. As shown in FIG. 9, the theme-based learning challenge may include ‘You and your friend are paddleboarding. Your friend is snacking and throwing candy wrappers in the water. Explain to you friend about maintaining sustainable water bodies’.

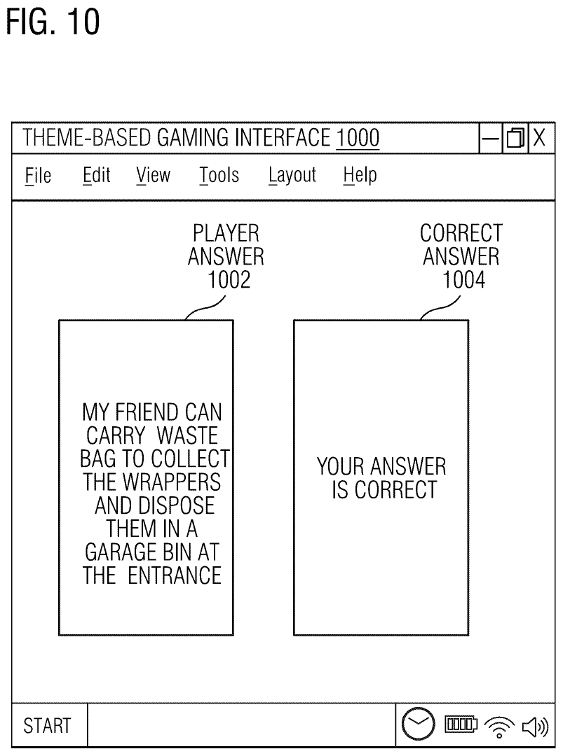

FIG. 10 is a graphical view of a thematic gaming interface 1000 displaying result of an answer to a theme-based learning challenge by a player, according to an embodiment. The thematic gaming interface 1000 displays an answer given by a player to a theme-based learning challenge displayed on the thematic gaming interface 900 in a player's answer field 1002. The thematic gaming interface 1000 also displays whether answer is correct or not in a correct answer field 1004. This enables the players to learn and gain knowledge by playing a thematic game. The thematic gaming interface 1000 may display number of questions correctly answered by players of a board game.

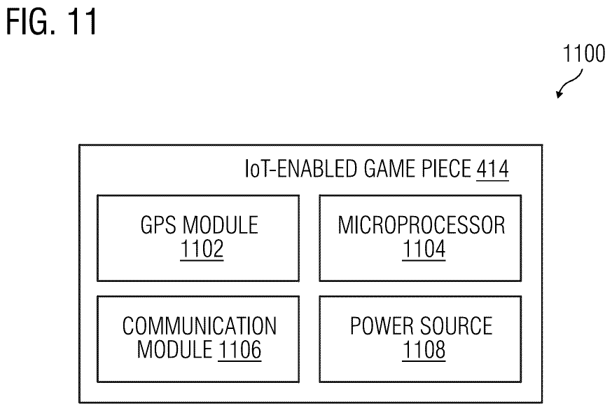

FIG. 11 is a block diagram of an IoT-enabled game piece 414 such as those shown in FIG. 4, according to an embodiment. The IoT-enabled game piece 414 is communicatively coupled to a gaming apparatus 416 via the Internet 426. The IoT-enabled game piece 414 is assigned to players of a theme-based learning game. The IoT-enabled game piece 414 is capable of determining its position on a physical game board and communicating the position data to the gaming apparatus 416 via the Internet 426.

The IoT-enabled game piece 414 includes a GPS module 1102, a microprocessor 1104, a communication module 1106, and a power source 1108. The GPS module 1102 is configured to determine position of the IoT-enabled game piece 414 on the physical game board 402. For example, the GPS module 1102 may determine position coordinates (X,Y) with respect to the physical game board 402. The microprocessor 1104 is configured to process the position data from the GPS module 1102 to determine whether there is a change in position of the IoT-enabled game piece 414. The microprocessor 1104 is configured to transmit the position data of the IoT-enabled game piece 414 to the gaming apparatus 416 in real-time. In some embodiments, the microprocessor 1104 is configured to transmit the position data of the IoT-enabled game piece 414 when the position of the game piece 414 has changed on the physical board game 402.

The communication module 1106 is configured to establish a communication session with the gaming device 416. The communication module 1106 is also configured to communicate the position data of the respective game piece 414 to the gaming apparatus 416. The power source 1108 is configured to supply power to the GPS module 1102, the microprocessor 1104, and the communication module 1106. The power source 1108 may be a rechargeable battery or lithium coin battery.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The present description has been shown and described with reference to the foregoing examples. It is understood, however, that other forms, details, and examples can be made without departing from the spirit and scope of the present subject matter that is defined in the following claims.

What is claimed is:

1. A thematic game-based learning system comprising:
at least one server; and
one or more user devices communicatively coupled to the server via a network, each user device is associated with a player, wherein the server comprises a theme-based learning module configured to:
generate a virtual game board having a plurality of spaces, wherein the plurality of spaces comprise a start space, and an end space, wherein one or more of spaces of the plurality of spaces between the start space and the end space comprises icons of different types, wherein each type of icon corresponds to a unique knowledge-based learning sub-theme;
generate one or more stacks of virtual cards, wherein said each stack of virtual cards corresponds to the knowledge-based learning sub-theme, and wherein each virtual card from the stack of virtual cards comprises a theme-based learning challenge;
determine a number indicated on a dice when a player rolls the dice;
move a virtual game piece of the player in a forward direction by one or more spaces in the virtual game board displayed on the user devices from previous position based on the number indicated on the rolled dice;
dynamically select a virtual card from the stack of virtual cards corresponding to a type of icon on which the virtual game piece is positioned; and
display the theme-based learning challenge on the selected virtual card on the respective user devices.

2. The thematic game-based learning system of claim 1, wherein the theme-based learning module is configured to:
determine whether an answer from the player to the theme-based learning challenge on the displayed virtual card is correct;
if it is determined that the answer from the player is not correct, move the virtual game piece of the player backwards on the displayed game board by at least one space from the current position; and
if it is determined that the answer from the player is correct, determine a number on the dice rolled by the player and move the virtual game piece of the player by one or more spaces on the displayed game board from the previous position based on the determined number on the dice.

3. The thematic game-based learning system of claim 1, wherein said each user device comprises an image capturing unit configured to capture an image of the top surface of the dice when each player rolls the dice.

4. The thematic game-based learning system of claim 2, wherein said each user device comprises a voice capturing unit configured to capture the answer corresponding to the theme-based learning challenge on the displayed virtual card.

5. The thematic game-based learning system of claim 4, wherein the theme-based learning module is configured to:
receive the captured answer corresponding to the theme-based learning challenge from said each device; and
determine whether the answer from the player to the theme-based learning challenge on the displayed virtual card is correct using a trained machine learning model based on the correct answer.

6. The thematic game-based learning system of claim 5, wherein the theme-based learning module is configured to:
determine whether the virtual game piece is positioned on the space having the icon;
if the virtual game piece is positioned on the space having the icon, determine the type of the icon on which the virtual game piece is positioned; and
dynamically select the virtual card from the corresponding stack of virtual cards corresponding to the type of icon.

7. The thematic game-based learning system of claim 2, wherein the theme-based learning module is configured to move the virtual game piece of the player backwards to the previous position of the virtual game piece on the virtual game board.

8. The thematic game-based learning system of claim 1, wherein the theme-based learning module is configured to dynamically generate the virtual game board with the plurality of spaces divided into two or more zones, wherein each zone corresponds to the unique knowledge-based learning sub-theme.

9. A thematic game-based learning apparatus comprising:
a physical game board having a plurality of spaces, wherein the plurality of spaces comprises a start space, and an end space, wherein one or more of spaces of the plurality of spaces between the start space and the end space comprise one or more icons of different types, wherein each type of icon corresponds to a unique theme;
two or more IoT-enabled game pieces assigned to players;
a dice having six sides numbered 1 to 6;
a processing unit communicatively coupled to the one or more IoT-enabled game pieces, wherein the processing unit comprises a theme-based learning module configured to:
dynamically generate one or more stacks of virtual cards, wherein said each stack of virtual cards corresponds to each type of icons, and wherein each virtual card in the stack of virtual cards comprises a unique theme-based learning challenge;
determine location of the game piece associated with each player on the game board when the game piece is moved to a new position on the game board after rolling of the dice;
select a virtual card from the stack of virtual cards corresponding to the type of icon on which the game piece is positioned; and
a display unit coupled to the processing unit configured to display the virtual card with the theme-based learning challenge.

10. The thematic game-based learning apparatus of claim 9, further comprising a voice capturing unit configured to capture the answer corresponding to the theme-based learning challenge on the displayed virtual card from the player associated with the IoT-enabled game piece.

11. The thematic game-based learning apparatus of claim 10, wherein the theme-based learning module is configured to:
determine whether the captured answer from the player to the theme-based learning challenge on the displayed virtual card is correct; and
render result of the answer to the theme-based learning challenge on the display unit, wherein the IoT-enabled game piece of the player is moved backwards on the game board by at least one space if the answer of the player is not correct; and the player is given another chance to roll the dice if the answer of the player is correct.

12. The thematic game-based learning apparatus of claim 10, wherein in determining whether the captured answer from the player to the theme-based learning challenge on the displayed virtual card is correct, the theme-based learning module is configured to:
receive the captured answer corresponding to the theme-based learning challenge from the voice capturing unit; and
determine whether the received answer from the player to the theme-based learning challenge on the displayed virtual card is correct using a trained machine learning model based on a correct answer.

13. The thematic game-based learning apparatus of claim 12, wherein the theme-based learning module is configured to:
determine whether the IoT-enabled game piece is positioned on the space having the icon on the game board;
if the IoT-enabled game piece is positioned on the space having the icon, determine the type of the icon on which the IoT-enabled game piece is positioned; and
dynamically select the virtual card from the stack of virtual cards corresponding to the icon.

14. The thematic game-based learning apparatus of claim 13, wherein in determining whether the IoT-enabled game piece is positioned on the space having the icon on the game board, the theme-based learning module is configured to:
determine the position of the IoT-enabled game piece based on location information received from the IoT-enabled game piece;
map the position of the IoT-enabled game piece to a virtual replica of game board based on the position of the IoT-enabled game piece; and
determine whether the position of the IOT-enabled game piece corresponds to the location of the icon on the virtual replica of game board.

15. The thematic game-based learning apparatus of claim 9, wherein the game board with the plurality of spaces is divided into two or more zones, wherein each zone corresponds to a unique sub-theme.

16. A thematic game-based learning kit comprising:
a game board having a plurality of spaces, wherein the plurality of spaces comprises a start space, and an end space, wherein one or more of spaces of the plurality of spaces between the start space and the end space comprises icons of one or more types, wherein each type of icon corresponds to a unique knowledge-based learning sub-theme;
at least one dice consisting of six sides indicating numbers 1 to 6;
two or more game pieces assigned to two or more players;
one or more stacks of cards, wherein each stack of cards corresponds to the knowledge-based learning sub-theme, wherein each card from the stack of cards comprises an unique theme-based learning challenge, wherein the game piece of the player who rolled the dice is moved by one or more spaces on the game board from previous position on the game board in the direction of the end space based on the number indicated on the rolled dice, wherein a card is drawn from the stack of cards corresponding to a type of icon if the game piece associated with the player is positioned on the icon after rolling the dice, and wherein the player is given a chance to answer the theme-based learning challenge on the card.

17. The thematic game-based learning kit of claim 16, wherein the game board consists of the plurality of spaces in the form of a track, and wherein the plurality of spaces is divided into two or more zones, each zone corresponds to the knowledge-based learning sub-theme.

18. The thematic game-based learning kit of claim 16, wherein the answer to the theme-based learning challenge is provided on back of the card.

19. The thematic game-based learning kit of claim 16, wherein the game piece is moved backwards on the game board by at least one space if the answer to the theme-based learning challenge on the drawn card is not correct, and wherein the player is given additional chance to roll the dice if the answer to the theme-based learning challenge is correct.

20. The thematic game-based learning kit of claim 16, wherein each game piece is an IoT-enabled game piece configured to:
determine position with respect to the game board when the IoT-enabled game piece is moved from the previous position to the new position upon rolling the dice, wherein the position is indicative of location of the IoT-enabled game piece on the game board; and
communicate position data indicating the position of the IoT-enabled game piece to a processing unit such that the processing unit dynamically selects a virtual card from a stack of virtual cards corresponding to the icon if the IoT-enabled game piece is positioned on the icon.
